(19) United States
(12) Patent Application Publication
(10) Pub. No.: US 2008/0030630 A1
(43) Pub. Date: Feb. 7, 2008

(54) Multi-positional rear projection television

(75) Inventor: Kenneth K. Li, Castaic, CA (US)

Correspondence Address: FULBRIGHT & JAWORSKI, LLP, 666 FIFTH AVE, NEW YORK, NY, 10103-3198, US

(73) Assignee: WAVIEN, INC.

(21) Appl. No.: 11/820,060

(22) Filed: Jun. 18, 2007

Related U.S. Application Data
(60) Provisional application No. 60/814,606, filed on Jun. 16, 2006.
(60) Provisional application No. 60/819,655, filed on Jul. 10, 2006.
(60) Provisional application No. 60/844,587, filed on Sep. 13, 2006.

(51) Int. Cl. H04N 5/64

(52) U.S. Cl. 348/789; 348/E05.128

(57) ABSTRACT

A multi-positional rear projection television (RPTV) capable of being placed in varying positions without compromising the orientation of the displayed image includes a projection engine for producing an image, a screen for displaying an image to an audience, a reflector for reflecting an image to a screen, image inversion circuitry for adjusting an orientation of the image to the vantage orientation of an audience depending on the position of the multi-positional RPTV, and a casing defining a substantially triangular cavity for housing at least the screen and the reflector. The screen is tilted with respect to the reflector, such that the casing forms a substantially triangular cavity with substantially zero footprint, thereby permitting the multi-positional RPTV to be mounted on a wall.

### CROSS REFERENCE TO RELATED APPLICATION

The present application claims the benefit of U.S. Provisional Application Ser. No. 60/814,606 filed Jun. 16, 2006, U.S. Provisional Application Ser. No. 60/819,655 filed Jul. 10, 2006 and U.S. Provisional Application Ser. No. 60/844,587 filed Sep. 13, 2006, each of which is incorporated herein by reference in their entirety.

### BACKGROUND

As the resolution of televisions has increased, consumers have been able to enjoy and view images on larger screen televisions at a closer distance without the drawback of discerning the actual lines and pixels that make up the image. As such, there has been an increased consumer desire and demand for larger screen televisions. The space occupied by a rear projection television (RPTV) increasingly becomes a concern in the minds of the consumer and limits its growth in the market place. As such, the RPTVs cannot effectively compete with the plasma or LCD televisions (collectively referred to herein as the “flat panel” TVs), which are generally thinner and cannot be wall mounted. An example of such a typical wall-mountable LCD or plasma TVs is shown in FIG. 1, which requires a sturdy mounting bracket to secure the LCD or plasma TV onto the wall. While LCD and plasma TVs lend themselves to space-saving wall-mountable configurations, they tend to be more expensive, heavy and consume more power than RPTVs. Although the plasma and LCD TVs are generally thinner than the RPTVs, the weight of the RPTV is less than half of the weight of a comparably sized plasma or LCD TV.

Therefore, the present invention proceeds upon the desirability of taking weight and other advantages of a RPTV to provide a mountable RPTV, thereby enabling the RPTVs to compete more effectively against the plasma and LCD TVs in the market place. Additionally, the present invention proceeds upon the desirability of providing multi-positional RPTVs, thereby enabling the consumer to position the RPTV in any desired orientation, e.g., landscape, portrait, inverted, etc.

### OBJECT AND SUMMARY OF THE INVENTION

It is an object of the present invention to provide a mountable RPTV that can compete with mountable plasma and LCD TVs.

Another object of the present invention is to provide a multi-positional RPTV which controls the orientation of the image displayed on the screen to match the viewing orientation of a viewer.

A further object of the present invention is to provide a kit for assembling a RPTV.

The present invention is directed to a multi-positional RPTV that satisfies the need for a more flexible, less expensive, lighter, more energy efficient alternative to LCDs and plasmas.

In accordance with an exemplary embodiment of the present invention, a mountable RPTV is provided which can be mounted on a wall to effectively compete with plasma and LCD TVs in the market place. The mountable RPTV comprises a housing having a mounting bracket, a projection engine for projecting an image, which is disposed at the upper portion of the housing, a screen for projecting an image and a reflector for reflecting the image from the projection engine onto the screen. The screen and the reflector wedge downward such that the housing forms a wedge shaped cross-section with a substantially zero footprint.

In accordance with an exemplary embodiment of the present invention, the mountable RPTV comprises a screen and a projection housing which is detachably connectable to the screen housing. The screen housing comprises a mounting bracket and houses a screen for displaying the image and a reflector for reflecting the image onto the screen. The projection housing comprises and houses a projection engine for projecting an image onto the screen through reflector when the projection housing is operably connected to the screen housing. Preferably, the projection housing is pre-aligned to the screen housing.

In accordance with an exemplary embodiment of the present invention, the multi-positional RPTV comprises a projection engine, a screen and a reflector, an image inversion circuitry and a housing. The projection engine projects image onto the screen through the reflector. The image inversion circuitry controls the orientation of the image displayed on the screen to match the viewing orientation of the viewer. Preferably, the screen is tilted with respect to the reflector such that the housing forms a wedge shaped cross-section with a substantially zero footprint when it is mounted on a wall. Also, preferably, the multi-positional RPTV is mounted with the back panel of the housing flush to the wall, thereby providing a natural tilt to enhance the viewing angle for the viewer.

In accordance with an exemplary embodiment of the present invention, there is provided a kit for assembling RPTV, preferably the mountable RPTV. The kit comprises a screen housing a multi-positional RPTV is provided comprising: a projection engine, a screen, a reflector, image inversion circuitry, and a casing. The image inversion circuitry adjusts the orientation of the image displayed on the screen of the RPTV relative to the physical position of the RPTV so that the image is oriented to the vantage point of a viewer.

In accordance with an exemplary embodiment of the present invention, a multi-positional RPTV is provided comprising: a projection engine, a screen, a reflector, a first casing, and a second casing external to the first casing to house the projection engine. The second casing that houses the projection engine is detachably attached to the first casing.

In accordance with an exemplary embodiment of the present invention, a first multi-positional RPTV is attached to a second multi-positional RPTV to form a single dual-display unit having a display screen on each side of the single unit.

In accordance with an exemplary embodiment of the present invention, a kit for assembling rear projection television (RPTV) is provided. The kit comprises a housing comprising a front panel, a back panel, a bottom panel and two side panels; a projection engine for projecting an image; a screen mountable on the front panel for displaying the image; and a reflector mountable on the back panel for receiving the image from the projection engine and reflecting the image onto the screen. The screen is tilted with respect to the reflector when assembled such that the housing forms a wedge shaped cross-section.

These and other features, aspects, and advantages of the present invention will become better understood with reference to the following description and appended claims.

### DESCRIPTION OF THE DRAWINGS

Embodiments of the present invention will be described with reference to the attached drawings in which like components or features in the various figures are represented by like reference numbers:

FIG. 1 is a side-view of a conventional wall-mounted flat panel television such as an LCD or plasma;

FIG. 2 is a chart illustrating the differences in cost, weight, and energy consumption among conventional LCDTV, plasma TV, and RPTV;

FIG. 3a-b are side-view and front view of a conventional RPTV;

FIG. 4 is side-view of a conventional RPTV mounted on a wall via a wall mounted shelf unit;

FIG. 5 is a side-view of a ZRPTV in accordance with an exemplary embodiment of the present invention;

FIG. 6 is a perspective view of ZRPTV with an external projection engine in accordance with an exemplary embodiment of the present invention;

FIG. 7 is a side-view of a multi-positional RPTV in accordance with an exemplary embodiment of the present invention;

FIG. 8 is a perspective view of the multi-positional RPTV of FIG. 7 positioned vertically according to an exemplary embodiment of the present invention;

FIG. 9 is a perspective view of two multi-positional RPTVs of FIG. 7 placed back-to-back to form a single dual-display unit in accordance with an exemplary embodiment of the present invention;

FIG. 10 is a schematic diagram of components of the RPTV;

FIG. 11 is a schematic diagram of components of the RPTV connected to a set top box;

FIGS. 12-13 are schematic diagrams of a component RPTV in accordance with an exemplary embodiment of the present invention;

FIG. 14 is a schematic diagram of various components of the RPTV housing or casing; and

FIG. 15 is a perspective view of projection engine with alignment pins in accordance with an exemplary embodiment of the present invention.

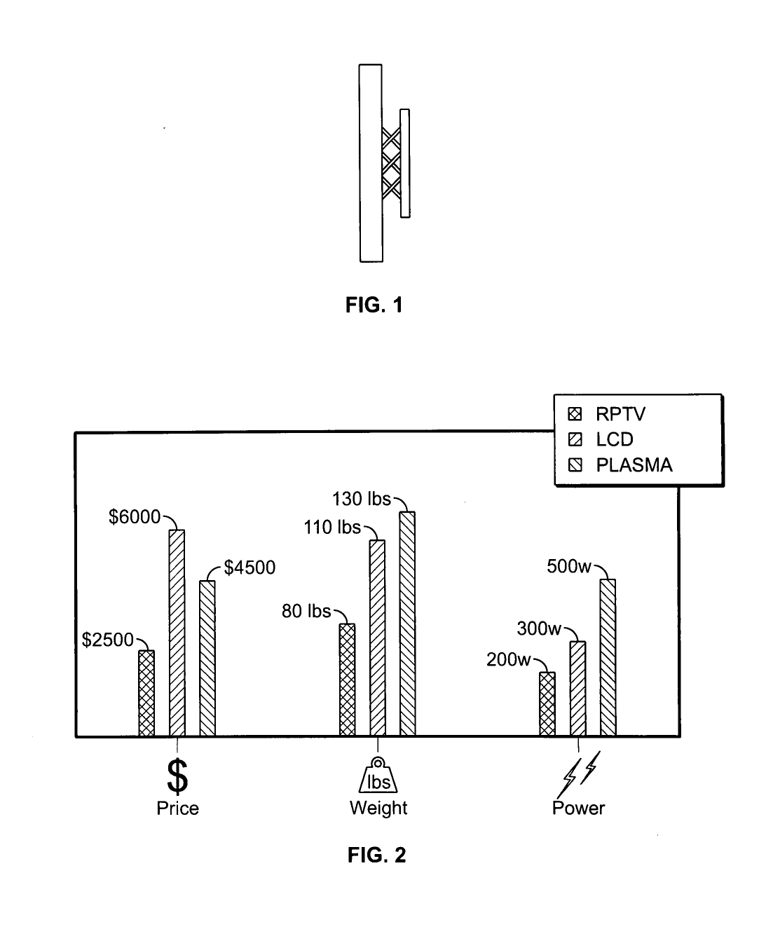

### DESCRIPTION

With reference to the figures, exemplary embodiments of the invention are now described. These embodiments illustrate principles of the invention and should not be construed as limiting the scope of the invention.

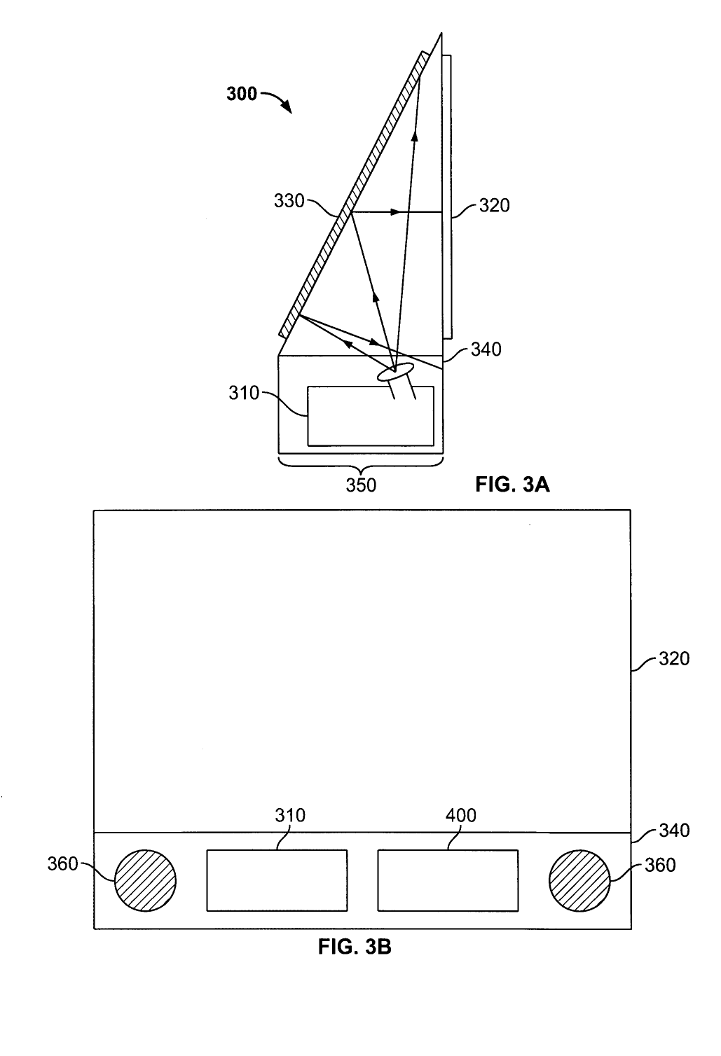

FIGS. 3a-b are schematic diagrams of a typical rear projection television (RPTV) 300. FIG. 3a shows the side view of the RPTV 300 with a screen 320 facing the front towards the viewer and a slanting reflector or mirror 330 reflecting the light (e.g., image) from a projection engine 310 onto the screen 320. The projection engine 310 being at the bottom of the RPTV cabinet to provide a substantial footprint 350 for stability.

FIG. 3b shows the front view of the RPTV 300. The projection engine 310 at the bottom of the housing/cabinet 340. Depending on the optical design, part of the projection engine 310 can be within the screen 320 to minimize the “chin” (the distance between the screen 320 and the bottom of the RPTV 300). The speakers 360 and other electronics 400 such as tuner, audio amplifier and the like are also at the bottom of the cabinet 340.

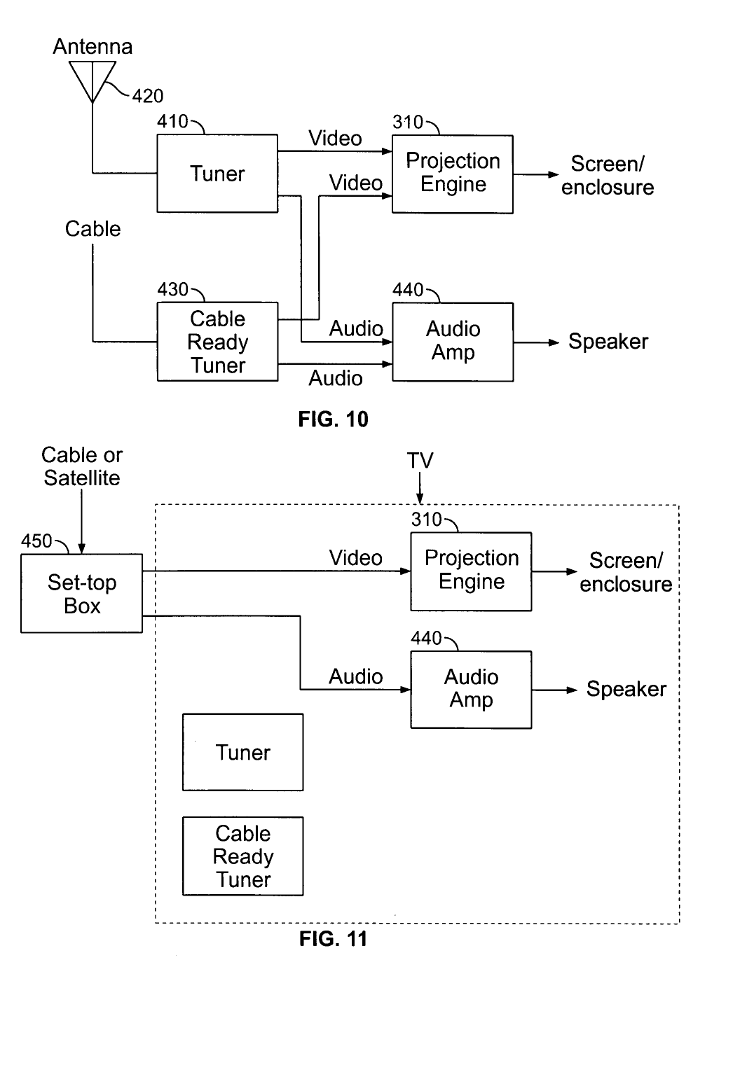

FIG. 10 is a schematic diagram showing typical components of the RPTV 300. the RPTV 300 generally consists of a tuner 410 for capturing signal from an antenna 420 and a cable ready tuner 430 for coupling the signal from the cable service provider directly into the RPTV without an external set-top or cable box. The video signal from the tuner or the cable ready tuner 430 drives the projection engine 310 and the audio signal from the tuner 410 or the cable ready tuner 430 is fed to the audio amplifier 440.

In the majority of the homes today, the broadcast TV signals do not come from antenna any more. Instead, most home owners and viewers subscribe to either cable or satellite services. These services usually come with a set-top box 450 as shown in FIG. 11 with various advance functions, such as digital video recorder, two-way communication for pay-per-view, etc. The output of these set top boxes 450 consists of video, audio, component, S-video, high-definition multimedia interface (HDMI), which are connect to the video, audio, component, S-video and HDMI input connectors. In this case, the antenna tuner and the cable ready tuner are not used.

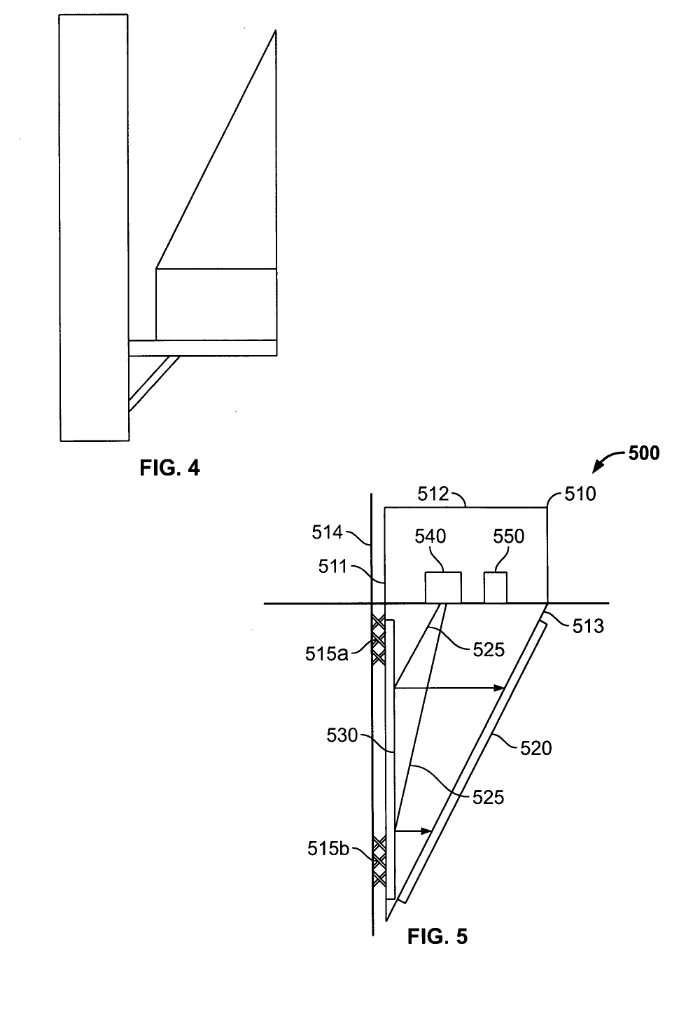

RPTVs 300 are generally cheaper, lighter, and consume less power than LCD and plasma TVs (collectively referred to herein as the flat panel TVs). For example, as shown in FIG. 2, a 60 inch RPTV cost approximately $3500 less than a similarly sized LCD TV, and $2000 less than a similarly sized plasma TV. The RPTV weighs approximately 50 lbs less than the similarly sized plasma TV and 30 pounds less than the similarly sized LCD TV. Moreover, the RPTV consumes 300 watts less than the similarly sized plasma TV and 100 watts less than the similarly sized LCD TV. The main drawback with conventional RPTVs, however, is that they compromise floor space because they require a base portion large enough to provide stability and to accommodate a projection engine 310 (see FIG. 3a). The base portion is aptly known as the RPTV's “footprint” (shown in FIG. 3a as footprint 350). While RPTV's can be placed on mounted shelves as shown in FIG. 4, that configuration is simply not functional as it still requires a mounting shelf large enough to accommodate the footprint 350 of the RPTV 300. Moreover such a mounting may compromise the image relative to the viewer. As such, though cheaper, lighter, and more energy efficient, RPTVs 300 are much less popular than LCD and plasma TVs.

The present invention proceeds upon desirability of taking weight, cost and power advantages of the RPTV to provide a mountable RPTV with substantially zero footprint. In accordance with an exemplary embodiment of the present invention, FIG. 5 shows a side-view of a mountable RPTV 500. The mountable RPTV 500 has virtually a zero footprint. The zero footprint RPTV 500 (“ZRPTV 500”) according to an exemplary embodiment of the present invention comprises a projection engine 540, a screen 520, a reflector or mirror 530, and a housing or casing 510 for housing the projection engine 540, the screen 520, and the reflector or mirror 530. The housing or casing 510 is preferably comprised of at least three panels: a back panel 511, a top panel 512, and a front panel 513. In this exemplary embodiment, the back panel 511 and top panel 512 are connected to each other perpendicularly as this facilitates a relatively flush interface between the back-panel 511 and the wall 514. As shown in FIG. 5, the front panel 513 is connected to the top panel 512 at one end and to the back panel 511 at the other end such that the back panel 511 and front panel 513 form a wedge-shaped cavity to provide a substantially zero footprint at the bottom of the ZRPTV 500.

This wedge-shaped housing or casing configuration not only eliminates any footprint at the bottom of the ZRPTV 500, it creates a wider cavity space at the top of the ZRPTV casing 510 for placing the projection engine 540. As shown in FIG. 5, in accordance with an exemplary embodiment of the present invention, the housing or casing 51 generally forms a triangular or wedge-shaped cavity, and the front panel 513 generally delineates the hypotenuse of the triangular cavity. It should be understood that the present invention contemplates additional embodiments of casing or housing 510 having any shape that generally increases the area of the upper cavity to accommodate the projection engine and decreases the area of the bottom portion of the ZRPTV to substantially eliminate a footprint including but not limited to casings formed of more than three panels or less than three panels.

As shown in FIG. 5, the projection engine 540 is disposed in the upper portion of the ZRPTV casing or housing 510 thereby allowing for the elimination of a footprint at the base of the ZRPTV 500. Reflector or mirror 530 is conventionally mounted on back panel 511 and functions in a manner known to those of skill in the art to optically receive an image 525 from projection engine 540 and reflect the image 525 onto the screen 520. Screen 520 is conventionally mounted on front panel 513 and displays the image 525 reflected from reflector 530 to an audience or viewer in a manner known to those of skill in the art. The image 525 is projected in the orientation that matches the visual perception of the viewer. In an alternate embodiment, screen 520 can be mounted onto back panel 511 and reflector 530 can be mounted to front panel 513.

As the ZRPTV of the present invention has virtually a zero footprint, it is particularly attractive for wall mounting or for display purposes in shopping malls or other public places. As shown in FIG. 5, ZRPTV 500 is mounted to wall 514 by mounting brackets 515a and 515b, so that back panel 511 is essentially flush with wall 514 thereby substantially eliminating any footprint of ZRPTV 500.

As shown in FIG. 5, the screen 520 is slightly tilted downward toward the ground because of the triangular cross-sectional shape of the housing 510. This natural slight tilting downward is a desirable feature because it optimizes the viewing perspective of the viewer. In fact, mounted LCD and plasma TVs are often mounted a slightly tilt position to optimize the viewing perspective of the audience. The natural tilt of the ZRPTV 500 when mounted to a wall eliminates the need for a sturdy, adjustable mounting bracket required for mounting the heavier LCD and plasma TVs. However, the consumer can also mount the ZRPTV 500 using adjustable mounting bracket to increase or decrease the tilt angle of the screen 520 with respect to the ground.

In addition, LCDs, plasmas, and conventional RPTVs are generally inflexible with respect to image orientation. Yet, alternate positioning of televisions, for example in vertical positions as opposed to landscape positions, may be desirable if a user is seeking to maximize space or to create multi-screen displays. Generally, however, these televisions are configured and built to produce an image in a single orientation, often the landscape orientation. As such, these televisions cannot retain the integrity of their images relative to the viewer if these televisions are re-positioned in alternate configurations—such as vertically or upside down. To change the given orientation of any one of these televisions would result in the altering of the orientation of the image on the screen as well, resulting in a displayed image having an orientation that does not match the viewing orientation of the audience. Moreover, with respect to plasmas and LCDs, they are too heavy and too fragile to re-position freely, running the risk of extensive damage any time they are re-positioned. As such, the currently available LCDTVs, plasma TVs, and RPTVs suffer from an inflexibility that compromises a user's ability to maximize space or to create multi-screen displays without having to incur additional costs by buying multiple televisions having the desired orientations.

In accordance with an exemplary embodiment of the present invention, the ZRPTV 500 additionally comprises an image inversion circuitry 550 for automatically or manually controlling the orientation of the image displayed on the screen 520 to match the viewing orientation of the viewer, thereby providing a television which is more spatially functional and flexible than existing LCDTVs, plasma TVs and conventional RPTVs. Preferably, the image inversion circuitry 550 automatically detects the position of multi-positional RPTV 800 and automatically adjusts the orientation of the projected image such that the image is displayed right-side up. The ZRPTV 500 can be mounted on a wall as shown in FIG. 5 or set on the floor or mounted on a stand like a conventional RPTV 300 as shown in FIG. 3.

In accordance with an exemplary embodiment of the present invention, a multi-positional RPTV 800 is shown in FIG. 7, which can be set on a flat surface (e.g., a floor) for a standard tabletop configuration or mounted on a stand like a conventional RPTV 300 of FIG. 3, mounted on a wall like a ZRPTV 500 of FIG. 5 or set on the side in portrait mode as shown in FIG. 11. That is, the multi-positional RPTV 800 can be positioned in any position and the image conversion circuitry 850 automatically or manually controls the orientation of the image displayed on the screen 820 by the projection engine 840 through the reflector/mirror 830 to match the viewing orientation of the viewer. That is, the image inversion circuitry 850 properly displays the images on the screen 820 in multiple positions. The housing 810 of the multi-positional RPTV 800 preferably comprises at least a back panel 811, a bottom panel 812, a front panel 813 and two side panels 814. Although the screen 820 is shown in FIG. 7 as being mounted on the front panel 813, the screen 820 can be alternatively mounted on the back panel 811 with the reflector/mirror 830 mounted on the front panel 813. The housing or casing 810 generally forms a triangular or wedge shaped cavity. It should further be understood that the present invention contemplates additional embodiments of casing or housing 810 having any shape that generally increases the area of the cavity at one end to accommodate the projection engine 840 and decreases the area of the cavity at the opposite end of the RPTV including casings formed of more than three panels or less than three panels.

As shown in FIG. 7, the projection engine 840 is disposed in the widest portion of the RPTV casing 810. Reflector 830 is mounted on the back panel 811 (e.g., the hypotenuse of the triangular cavity) and functions in a manner known to those of skill in the art to optically receive an image 825 from the projection engine 840 and reflect the image 825 onto the screen 820. The screen 820 is mounted on front panel 813 and displays the image 825 reflected from the reflector 830 to a viewer in a manner known to those of skill in the art. The image inversion circuitry 850 is controllable to project image 825 onto screen 820 such that the orientation of the projected image 825 matches that of the visual perception of the audience. In accordance with an aspect of the present invention, the image inversion circuitry 850 controls the projection image 840 to project the image 825 in a desired orientation. Preferably, the image inversion circuitry 850 automatically detects the position of multi-positional RPTV 800 and automatically adjusts the orientation of the projected image 825 such that the image is displayed right-side up. It is appreciated that the image inversion circuitry 850 is any circuit, software, device or devices that operate to change the orientation of an image on a screen, such circuitry is known to those of skill in the art.

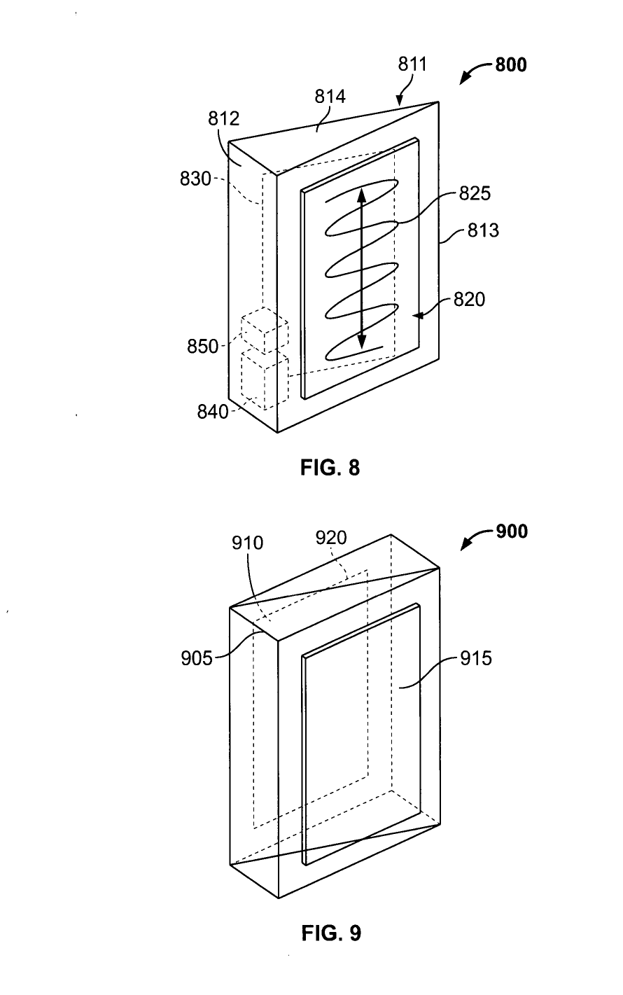

FIG. 8 shows a perspective view of the multi-positional RPTV of FIG. 7 positioned vertically according to an exemplary embodiment of the present invention. The multi-positional RPTV 800 is turned on its side resulting in a vertical position of multi-positional RPTV 800 and the image thereon displayed in portrait mode. The image inversion circuitry 850 adjusts the orientation of the image 825 such that the image 825 is right side up and therefore matches the viewing orientation or optical perception of a viewer. In this vertical configuration the widest portion of the multi-positional RPTV 800 is on the side and the projector engine 840 is therefore positioned in that side. By placing the projector engine 840 on the side instead of at the bottom or top in the vertical configuration reduces the thickness of the RPTV in portrait mode.

In accordance with an exemplary embodiment of the present invention, as shown in FIG. 9, multiple multi-positional RPTVs 800 can be placed together for enhanced display advantages such as having a display on two sides of a column or wall. FIG. 9 shows a perspective view of two inventive multi-positional RPTVs 800 placed back-to-back to form a single dual display unit in accordance with an exemplary embodiment of the present invention. This dual-display RPTV unit 900 is comprised of a first multi-positional RPTV 905 and a second multi-positional RPTV 910 placed back to-back such that the back panels 822 of each multi-positional RPTV 905, 910 are flush against each other. The dual-display RPTV unit 900 has a first screen 915 facing one side and a second screen 910 facing the other side. As such, it can be used for displays in shopping malls, airports, train stations, and other environments. Although the dual-display RPTV unit 900 is shown with multi-positional RPTVs 905, 910 in portrait mode, the position of the dual-display RPTV unit 900 can be rotated such that the multi-positional RPTVs 905, 910 display images in landscape mode. The image inversion circuitry 850 adjusts the orientation of the image 825 such that the image 825 is right side up and therefore matches the optical perception or viewing orientation of a viewer. In accordance with an aspect of the present invention, multiple multi-positional RPTVs 800 can be combined into different shapes and sizes to produce multiple images in either uniform or varying orientations. Also, in accordance with an exemplary embodiment of the present invention, as described herein, each multi-positional RPTVs 800 can have a separate projection housing for a projection engine 840 and/or image conversion circuitry 840. The separate projection housing is detachably attached to the housing 810 of the multi-positional RPTV.

In accordance with an exemplary embodiment of the present invention, the multi-positional RPTV 800 can include mounting brackets, such that the multi-positional RPTV 800 or combination of multiple RPTVs 800 can function and operate as a mountable ZRPTV 500.

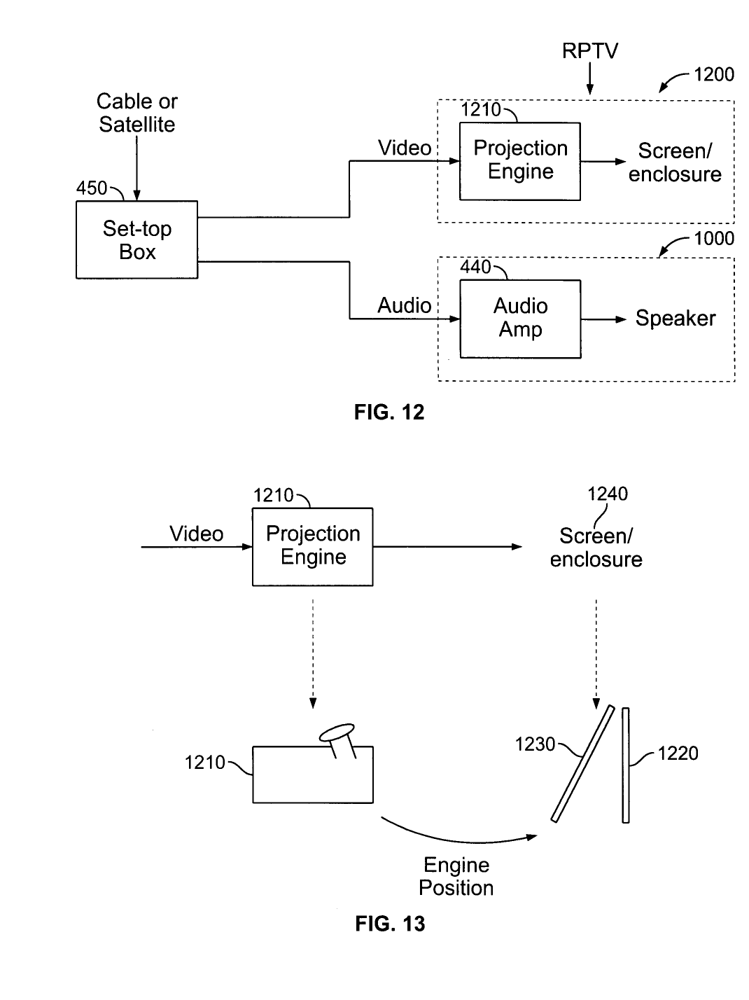

In accordance with an exemplary embodiment of the present invention, FIGS. 12-14 show a kit for a component RPTV 1200 having a minimum configuration. The component RPTV 1200 comprising a video monitor for receiving video output from the set top box 450. The kit for a minimum configuration of the component RPTV 1200 comprises a reflector or mirror 1230, a screen 1220, a projection engine 1210 and a housing or enclosure 1240. As described herein, the projection engine can be placed at the top or at the bottom of the housing 1240 depending whether the component RPTV 1200 is mounted on the wall or placed on a flat surface, e.g., a floor, for a standard tabletop configuration. The audio output of the set top box 450 is fed to a standard mono, stereo, or surround sound system 1000. In most homes these days, there are usually audio systems available to receive audio output from the set top box 450 and built-in audio system is not necessary in the minimum configuration of the component RPTV 1200 of the present invention. Additionally, since set top box 450 outputs video signals, tuners are not necessary, thus further reduce the cost of the system.

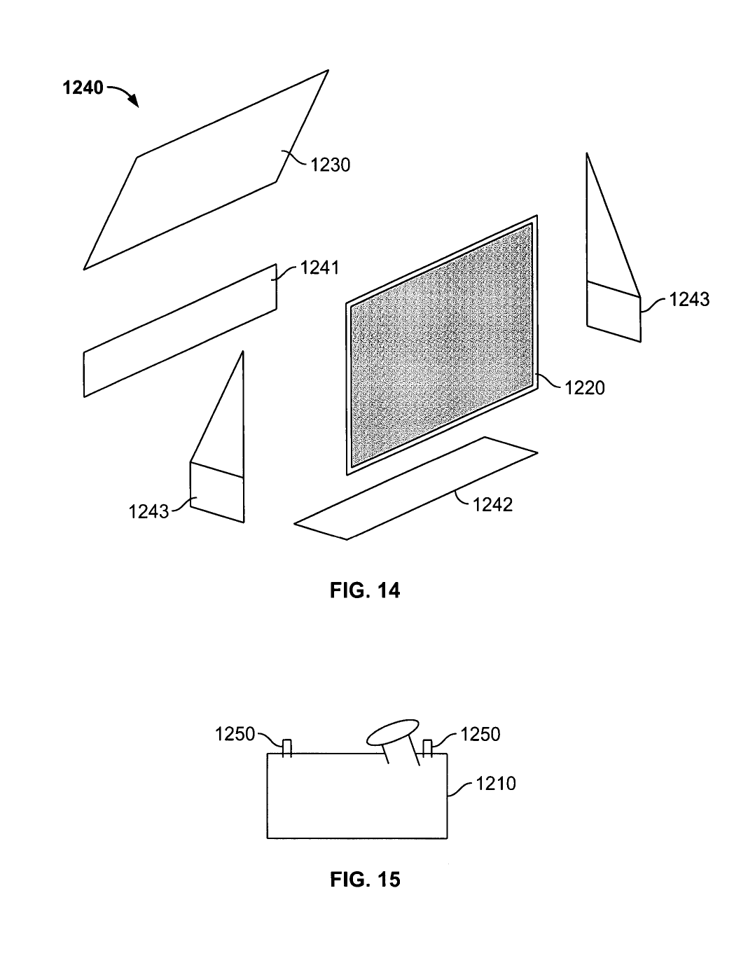

To further simplify the component RPTV 1200 of the present invention, the system can be broken down to a component configuration, as shown in FIG. 13 to lower the cost and for ease of transportation. The projection engine 1210 is separately packaged from the box including the mirror/reflector 1230, the screen 1220 and housing 1240 (see FIG. 14). As shown in FIG. 14, the housing 1240 of the component RPTV of the present invention comprises a back panel 1241, a bottom panel 1242, two side panels 1243, a mounted mirror/reflector 1230 and a screen 1220 with mounting. In order to ensure proper alignment between the projection engine 1210 and the screen 1220, in accordance with an exemplary embodiment of the present invention, the projection engine 1210 and the housing 1240 of the component RPTV 1200 additionally comprises an alignment mechanism or pins 1250 (as shown in FIG. 15) so that the user can assemble the component RPTV 1200 with the projection engine 1210 and the screen 1220 in proper alignment with each other.

In accordance with an exemplary embodiment of the present invention, the kit for component RPTV 1200 can additionally comprise an image inversion circuitry 850 so the user can build the ZRPTV 500 or multi-positional RPTV 800.

It is appreciated that the component RPTV 1200 of the present invention can lower the cost of the RPTV by introducing new manufacturers into the market place. For example, the projection engine 1210 and the housing/casing 1240 can be made by different manufacturers with different expertise. The projection engine 1210 can be made by an optical manufacturer, who may not have an expertise in making the housing/casing 1240. The housing 1240 can be made by a furniture manufacturer, who typically does not have any expertise in making projection engine 1210. Moreover, the component RPTV 1200 can be purchased as two separate items. Each item can be carried into the consumer's house or apartment with ease and the component RPTV kit of the present invention can be assembled by the consumer.

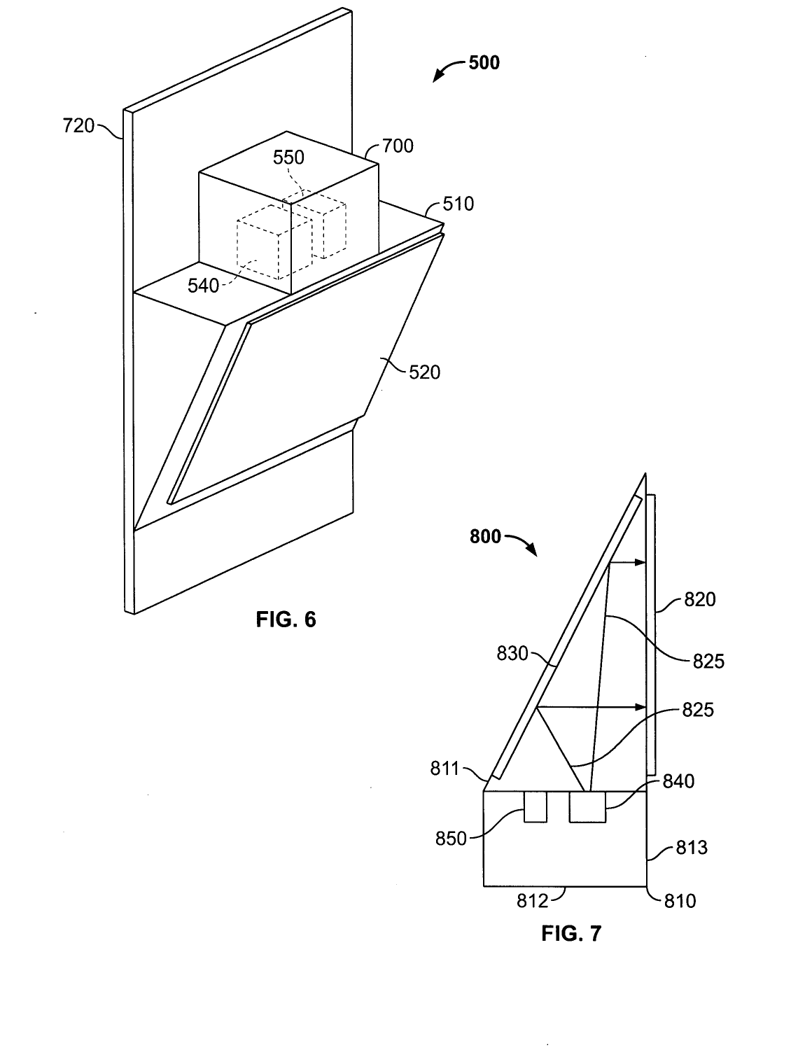

FIG. 6 shows a side-view of a ZRPTV 500 (or a multi-positional RPTV 800, not shown) with a detachable external projection engine 540 in accordance with an exemplary embodiment of the present invention. The projection engine 540 is externally housed in a separate projection engine casing or housing 700 and is detachably attached to the ZRPTV casing or housing 510. In practice this allows the ZRPTV 500 to be shipped in two boxes. One box contains the projection engine casing 700 housing the projection engine 540, and the other box contains the remaining parts of the RPTV 500 such as the housing or casing 510, the screen 520, reflector/mirror 530. Such a configuration facilitates repair and greatly simplifies the delivery and set up of the ZRPTV 500 as the individual components are lighter to mount onto the wall. As shown in FIG. 6, the projection engine casing 700 is positioned on top of the ZRPTV casing 510. The projection engine casing 710 is detachably connected to the top of casing 510 so that the projection engine 540 is in an optical alignment with the screen 520. In order to ensure proper alignment between the projection engine 540 and the screen 520, the projection housing 700 can be pre-aligned to the ZRPTV housing 510 using dowel pins and the like so that the screen 520 is in optical alignment with the projection engine 540. In accordance with an exemplary embodiment of the present invention, the projection engine housing 700 and the ZRPTV housing 510 additionally comprises an alignment mechanism or pins 1250 (as shown in FIG. 15) so that the user can assemble the ZRPTV 500 with the projection engine 540 and the screen 520 in proper alignment with each other. Preferably, the projection engine casing 700 rests in the middle of the top portion of the ZRPTV casing 510. This configuration evenly distributes the weight of projection engine casing 700 on the ZRPTV casing 510 so as not to disrupt the balance and mounting of ZRPTV 500 to the wall 720.

The previously described versions of the present invention have many advantages, including but not limited to a more flexible, less expensive, lighter, more energy efficient alternative to LCDs and plasmas that is also more spatially functional and flexible than existing RPTVs. By having the projector in the upper portion of the RPTV in accordance with an exemplary embodiment of the present invention, the mountable RPTV can be mounted onto a wall with virtually complete elimination of any footprint. As such, the mountable RPTV configuration in accordance with an exemplary embodiment of the present invention saves space and provides a less expensive, lighter and more energy efficient alternative to mounted LCDs and plasma televisions. By having a separable projection engine casing in accordance with an exemplary embodiment of the present invention, the RPTV can be shipped in separate boxes. The separable projection engine casing facilitates repair and simplifies delivery and set up of the RPTV. By including image inversion circuitry in a multi-positional RPTV in accordance with an exemplary embodiment of the present invention, the multi-positional RPTV can be positioned in many different positions that allow a user to maximize space and create multi-RPTV displays that are less expensive, less heavy, and more energy efficient than LCDs and plasmas. As such the multi-positional RPTV of the present invention solves the need for a less expensive, more flexible, lighter, and more energy efficient television than the currently available LCD, plasma, and conventional RPTVs.

Although the present invention has been described in considerable detail with reference to certain versions thereof, other versions are possible. For example, in an alternate embodiment, the multi-positional RPTV can comprise image inversion circuitry that can be remotely controlled either directly or remotely by a user, or in another embodiment the image inversion circuitry can automatically detect the orientation of the RPTV and adjust the image accordingly. Moreover, in yet another embodiment, the multi-positional RPTV can be combined into many different shapes to display images in many different configurations. The mountable RPTV according to a further embodiment of the present invention can be mounted on any surface including but not limited to a wall, a vehicle, a tree, a tent, or any other surface. Moreover, in accordance with yet an additional embodiment of the present invention, the casing for the RPTVs can be formed of more or less than three panels. Therefore, the spirit and scope of the appended claims should not be limited to the description of the embodiments herein.

What is claimed:

1. A mountable rear projection television (RPTV), comprising:
a housing comprising a mounting bracket;
a projection engine for projecting an image is disposed at upper portion of said housing of said mountable RPTV;
a screen for displaying said image; and
a reflector for reflecting said image from said projection engine onto said screen; and
wherein said screen and said reflector wedge downward such that said housing forms a wedge shaped cross-section with a substantially zero footprint.

2. The mountable RPTV of claim 1, wherein said screen is tilted with respect to said reflector.

3. The mountable RPTV of claim 1, further comprising an image inversion circuitry for controlling an orientation of said image displayed on said screen to match a viewing orientation of a viewer.

4. The mountable RPTV of claim 3, wherein said image inversion circuitry automatically controls said orientation of said image displayed on said screen to match said viewing orientation of said viewer.

5. The mountable RPTV of claim 3, wherein said image inversion circuitry is manually operable by said viewer to control said orientation of said image displayed on said screen to match said viewing orientation of said viewer.

6. The mountable RPTV of claim 3, wherein said mounting bracket is operable to mount said RPTV in an inverted position on a mounting stand; wherein said image inversion circuitry is operable to invert said orientation of said image displayed on said screen to match said viewing orientation of said viewer.

7. A mountable rear projection television (RPTV), comprising
a screen housing comprising a mounting bracket and housing a screen for displaying said image and a reflector for reflecting said image onto said screen;
a projection housing for housing a projection engine for projecting an image and detachably connectable to said screen housing; and
wherein said reflector is operable to reflect said image from said projection engine to said screen when said projection engine is operably connected to said screen housing.

8. The mountable RPTV of claim 7, wherein said screen and said reflector wedge downward such that said screen housing forms a wedge shaped cross-section with a substantially zero footprint.

9. The mountable RPTV of claim 7, wherein said projection housing is pre-aligned to said screen housing.

10. The mountable RPTV of claim 7, wherein said screen is tilted with respect to said reflector.

11. The mountable RPTV of claim 7, further comprising an image inversion circuitry for controlling an orientation of said image displayed on said screen to match a viewing orientation of a viewer.

12. The mountable RPTV of claim 11, wherein said image inversion circuitry automatically controls said orientation of said image displayed on said screen to match said viewing orientation of said viewer.

13. The mountable RPTV of claim 11, wherein said image inversion circuitry is manually operable by said viewer to control said orientation of said image displayed on said screen to match said viewing orientation of said viewer.

14. The mountable RPTV of claim 11, wherein said mounting bracket is operable to mount said RPTV in an inverted position on a mounting stand; wherein said image inversion circuitry is operable to invert said orientation of said image displayed on said screen to match said viewing orientation of said viewer.

15. A multi-positional rear projection television (RPTV), comprising:
a projection engine for projecting an image;
a screen for displaying said image;
a reflector for reflecting said image from said projection engine onto said screen;
an image inversion circuitry for controlling an orientation of said image displayed on said screen to match a viewing orientation of a viewer; and
a housing for housing said projection engine, said screen, said reflector and said image inversion circuitry.

16. The multi-positional RPTV of claim 15, wherein said housing comprises a mounting bracket for mounting said multi-positional RPTV on a wall or a mounting stand.

17. The multi-positional RPTV of claim 16, wherein said screen is tilted with respect to said reflector such that said housing forms a wedge shaped cross-section with a substantially zero footprint when said multi-positional RPTV is mounted on the wall.

17. The multi-positional RPTV of claim 15, wherein said image inversion circuitry automatically controls said orientation of said image displayed on said screen to match said viewing orientation of said viewer.

18. The multi-positional RPTV of claim 15, wherein said image inversion circuitry is manually operable by said viewer to control said orientation of said image displayed on said screen to match said viewing orientation of said viewer.

19. A display unit comprising a plurality of multi-positional RPTVs of claim 15, wherein said image inversion circuitry in each multi-positional RPTV is independently operable to control said orientation of said image displayed on said screen of said each multi-positional RPTV to match said viewing orientation of a viewer.

20. The display unit of claim 19 comprising two multi-positional RPTVs placed back-to-back.

21. A kit for assembling rear projection television (RPTV), the kit comprising
a housing comprising a front panel, a back panel, a bottom panel and two side panels;
a projection engine for projecting an image;
a screen mountable on said front or back panel for displaying said image; and
a reflector mountable on said front or back panel opposed to a panel having said screen mounted thereon for receiving said image from said projection engine and reflecting said image onto said screen; and
wherein said screen is tilted with respect to said reflector when assembled such that said housing forms a wedge shaped cross-section.

22. The kit of claim 21, wherein said projection engine and said housing comprise alignment mechanism to enable a user to assemble said kit with said projection engine and said screen in proper alignment with each other.

23. The kit of claim 21, wherein said projection engine is house in a separate projection engine casing, said projection engine casing being detachable connectable to said housing.

24. The kit of claim 23, wherein said projection engine and said housing comprise alignment mechanism to enable a user to assemble said kit with said projection engine and said screen in proper alignment with each other.

25. The kit of claim 21, wherein said screen and said reflector wedge downward such that said housing forms a wedge shaped cross-section with a substantially zero footprint.

26. The kit of claim 21, further comprising an image inversion circuitry for controlling an orientation of said image displayed on said screen to match a viewing orientation of a viewer.

27. The kit of claim 26, wherein said image inversion circuitry automatically controls said orientation of said image displayed on said screen to match said viewing orientation of said viewer.

28. The kit of claim 26, wherein said image inversion circuitry is manually operable by said viewer to control said orientation of said image displayed on said screen to match said viewing orientation of said viewer.

29. The kit of claim 21, wherein said assembled RPTV being connectable to a sound system to provide audio.

30. The kit of claim 21, further comprising audio amplifier and speakers.
